(19) United States
(12) Patent Application Publication
(10) Pub. No.: US 2009/0073363 A1
(43) Pub. Date: Mar. 19, 2009

(54) Crystal display screen

(75) Inventors: Wei-Qi Fu, Beijing (CN); Liang Liu, Beijing (CN); Kai-Li Jiang, Beijing (CN); Shou-Shan Fan, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: Tsinghua University, Beijing City (CN); HON HAI Precision Industry CO., LTD., Tu-Cheng City (TW)

(21) Appl. No.: 12/313,394

(22) Filed: Nov. 20, 2008

(30) Foreign Application Priority Data
Feb. 1, 2007 (CN) 200810066041.5

(51) Int. Cl. G02F 1/1337

(52) U.S. Cl. 349/128; 428/1.2; 977/742

(57) ABSTRACT

A liquid crystal display screen includes a first substrate, a first alignment layer, a liquid crystal layer, a second alignment layer, and a second substrate. The first substrate is opposite to the second substrate. The liquid crystal layer is sandwiched between the first substrate and the second substrate. The first alignment layer and the second alignment layer are respectively disposed on the first substrate and the second substrate facing the liquid crystal layer. The first alignment layer and the second alignment layer respectively include a plurality of parallel first grooves and second grooves. An alignment direction of the first grooves is perpendicular to that of the second grooves. Furthermore, at least one of the alignment layers includes a carbon nanotube layer and a fixing layer. The fixing layer is disposed on the carbon nanotube layer, and facing the liquid crystal layer.

### RELATED APPLICATIONS

This application is related to commonly-assigned applications entitled “LIQUID CRYSTAL DISPLAY SCREEN”, filed ______ (Atty. Docket No. US18573); “METHOD FOR MAKING LIQUID CRYSTAL DISPLAY SCREEN”, filed ______ (Atty. Docket No. US18575); “LIQUID CRYSTAL DISPLAY SCREEN”, filed ______ (Atty. Docket No. US19048); “LIQUID CRYSTAL DISPLAY SCREEN”, filed ______ (Atty. Docket No. US19049); “LIQUID CRYSTAL DISPLAY SCREEN”, filed ______ (Atty. Docket No. US19050); and “METHOD FOR MAKING LIQUID CRYSTAL DISPLAY SCREEN”, filed ______ (Atty. Docket No. US19051). The disclosures of the above-identified applications are incorporated herein by reference.

### BACKGROUND

1. Field of the Invention

The present invention relates to liquid crystal display screens, and, particularly, to a carbon-nanotube-based liquid crystal display screen.

2. Discussion of Related Art

Referring to FIG. 7, a conventional liquid crystal display screen 100 for a liquid crystal display (LCD), according to the prior art, generally includes a first substrate 104, a second substrate 112, and a liquid crystal layer 118. The first substrate 104 is disposed parallel to the second substrate 112. The liquid crystal layer 118 is located between the first substrate 104 and the second substrate 112. A first transparent electrode layer 106 and a first alignment layer 108 are formed in that order on an inner surface of the first substrate 104 that faces toward the liquid crystal layer 118. A first polarizer 102 is formed on an outer surface of the first substrate 104 that faces away from the liquid crystal layer 118. A second transparent electrode layer 114 and a second alignment layer 116 are formed in that order on an inner surface of the second substrate 112 that faces toward the liquid crystal layer 118. A second polarizer 110 is formed on an outer surface of the second substrate 112 that faces away from the liquid crystal layer 118.

The quality and performance of the alignment layers 108, 116 are key factors that determine the display quality of the liquid crystal display screen 100. A high quality liquid crystal display screen demands steady and uniform arrangement of liquid crystal molecules 1182 of the liquid crystal layer 118. This is achieved in part by correct arrangement of the liquid crystal molecules 1182 at the alignment layers 108, 116. Materials to make the alignment layers 108, 116 are typically selected from the group consisting of polystyrene, polystyrene derivative, polyimide, polyvinyl alcohol, epoxy resin, polyamine resin, and polysiloxane. The selected material is used to create a preform of each alignment layer 108, 116. The preform is then treated by one method selected from the group consisting of rubbing, incline silicon oxide evaporation, and atomic beam alignment micro-treatment. Thereby, grooves are formed on the treated surface of the preform, and the alignment layer 108, 116 is obtained. The grooves affect the arrangement and orientations of the liquid crystal molecules 1182.

In the liquid crystal display screen 100, the liquid crystal molecules 1182 are cigar-shaped. A plurality of parallel first grooves 1082 is formed at an inner surface of the first alignment layer 108. A plurality of parallel second grooves 1162 is formed at an inner surface of the second alignment layer 116. A direction of alignment of each of the first grooves 1082 is perpendicular to a direction of alignment of each of the second grooves 1162. The grooves 1082, 1162 function so as to align the orientation of the liquid crystal molecules 1182. In particular, the liquid crystal molecules 1182 adjacent to the alignment layers 108, 116 are aligned parallel to the grooves 1082, 1162 respectively. When the grooves 1082 and 1162 are at right angles and the substrates 104 and 112 are spaced an appropriate distance from each other, the liquid crystal molecules 1182 can automatically twist progressively over a range of 90 degrees from the top of the liquid crystal layer 118 to the bottom of the liquid crystal layer 118.

The polarizers 102 and 110 and the transparent electrode layers 106 and 114 play important roles in the liquid crystal display screen 100. However, the polarizers 102 and 110 and the transparent electrode layers 106 and 114 may make the liquid crystal display screen 100 unduly thick, and may reduce the transparency of the liquid crystal display screen 100. Moreover, the polarizers 102 and 110 and the transparent electrode layers 106 and 114 typically increase the cost of manufacturing the liquid crystal display screen 100.

What is needed, therefore, is to provide a liquid crystal display screen with simple structure, reduced thickness, and excellent arrangement of liquid crystal molecules.

### SUMMARY

A liquid crystal display screen includes a first substrate, a first alignment layer, a liquid crystal layer, a second alignment layer, and a second substrate. The first substrate is opposite to the second substrate. The liquid crystal layer is sandwiched between the first substrate and the second substrate. The first alignment layer is disposed on the first substrate, and faces the liquid crystal layer. The first alignment layer includes a plurality of parallel first grooves facing the liquid crystal layer. The second alignment layer is disposed on the second substrate, and faces the liquid crystal layer. The second alignment layer includes a plurality of parallel second grooves facing the liquid crystal layer. An alignment direction of the first grooves is perpendicular to that of the second grooves. Furthermore, at least one of the first alignment layer and the second alignment layer includes a carbon nanotube layer and a fixing layer. The fixing layer is disposed on the carbon nanotube layer, and faces the liquid crystal layer.

Other advantages and novel features of the present liquid crystal display screen will become more apparent from the following detailed description of the present embodiments when taken in conjunction with the accompanying drawings.

### BRIEF DESCRIPTION OF THE DRAWINGS

Many aspects of the present liquid crystal display screen can be better understood with reference to the following drawings. The components in the drawings are not necessarily to scale, the emphasis instead being placed upon clearly illustrating the principles of the present liquid crystal display screen.

FIG. 1 is a schematic, isometric view of a present liquid crystal display screen, in accordance with a present embodiment.

FIG. 2 is a cross-sectional schematic view of the liquid crystal display screen of the present embodiment, taken along a line II-II of FIG. 1.

FIG. 3 is a cross-sectional schematic view of the liquid crystal display screen of the present embodiment, taken along a line III-III of FIG. 1.

FIG. 4 shows a Scanning Electron Microscope (SEM) image of a carbon nanotube film covered with a fixing layer in the liquid crystal display screen of the present embodiment.

FIG. 5 is similar to FIG. 1 showing the liquid crystal display screen in a light transmitting state.

FIG. 6 is similar to FIG. 1, but showing the liquid crystal display screen in a light blocking state.

FIG. 7 is a schematic view of a conventional liquid crystal display screen according to the prior art.

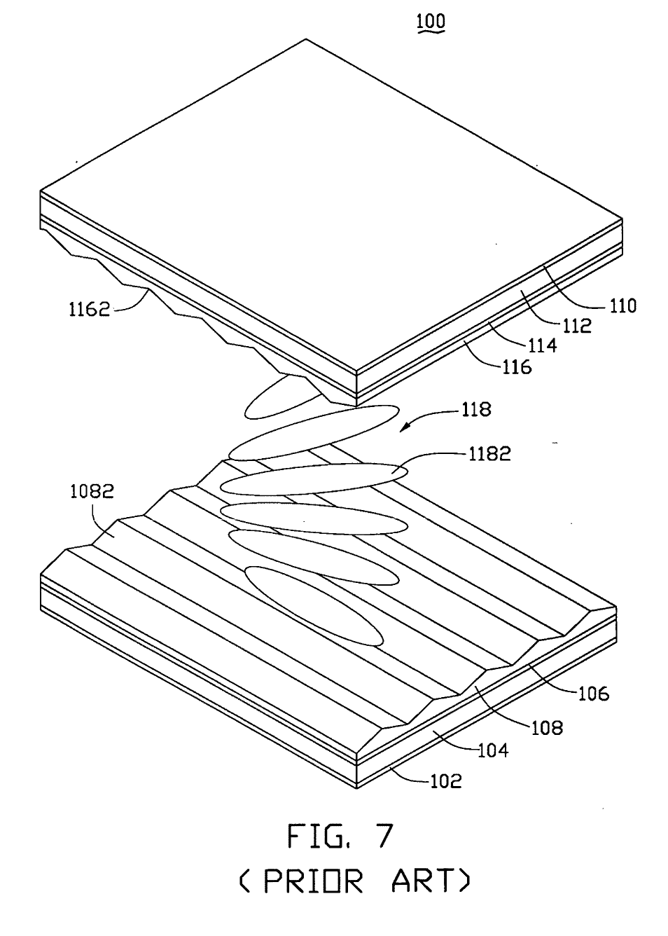

Corresponding reference characters indicate corresponding parts throughout the several views. The exemplifications set out herein illustrate at least one embodiment of the present liquid crystal display screen, in at least one form, and such exemplifications are not to be construed as limiting the scope of the invention in any manner.

### DETAILED DESCRIPTION OF EXEMPLARY EMBODIMENTS

Reference will now be made to the drawings to describe, in detail, embodiments of the present liquid crystal display screen.

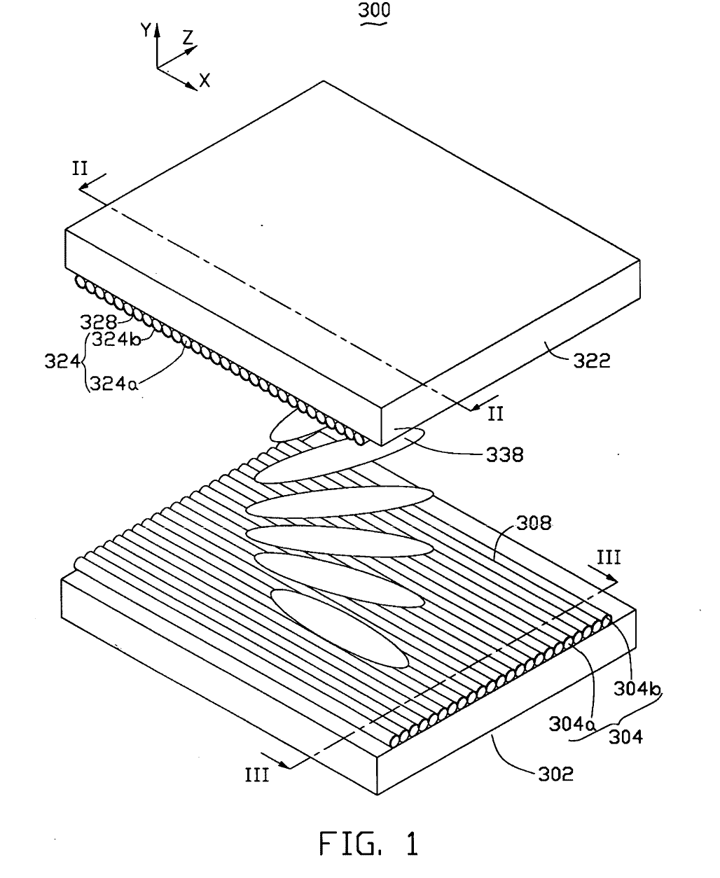

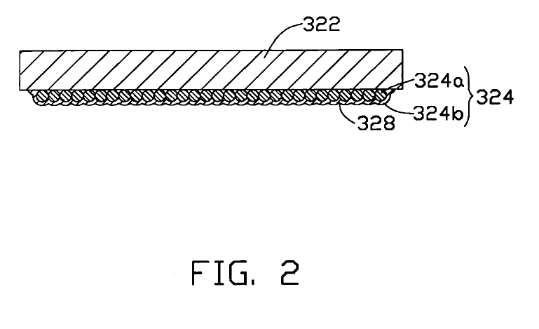

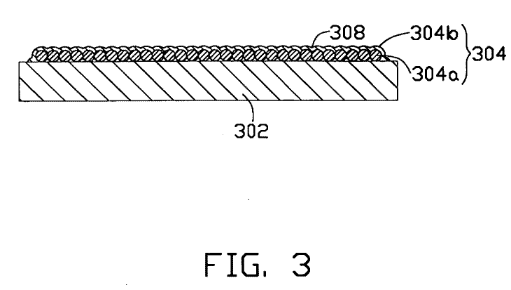

Referring to FIGS. 1, 2, and 3, a liquid crystal display screen 300 includes a first substrate 302, a first alignment layer 304, a liquid crystal layer 338, a second alignment layer 324, and a second substrate 322. The first substrate 302 is opposite to the second substrate 322. The liquid crystal layer 338 is sandwiched between the first substrate 302 and the second substrate 322. The first alignment layer 304 is disposed on the first substrate 302 and adjacent to the liquid crystal layer 338. The first alignment layer 304 includes a plurality of parallel first grooves 308 facing the liquid crystal layer 338. The second alignment layer 324 is disposed on the second substrate 322 adjacent to the liquid crystal layer 338. The second alignment layer 324 includes a plurality of parallel second grooves 328 facing the liquid crystal layer 338. An alignment direction of the first grooves 308 is perpendicular to an alignment direction of the second grooves 328.

The material of the first substrate 302 and the second substrate 322 can be glass, quartz, diamond, and plastics. In the present embodiment, the first substrate 302 and the second substrate 322 are made of flexible materials, such as cellulose triacetate (CTA).

The liquid crystal layer 338 includes a plurality of rod-like liquid crystal molecules. Understandably, the liquid crystal layer 338 can also be made of other suitable liquid crystal materials.

The first alignment layer 304 includes a carbon nanotube layer and a fixing layer. The fixing layer is disposed on the carbon nanotube layer facing the liquid crystal layer.

The carbon nanotube layer can be comprised of carbon nanotube films. Each carbon nanotube film includes a plurality of parallel carbon nanotube segments, which are joined end by end by van der Waals attractive force therebetween. Each carbon nanotube segment includes a plurality of carbon nanotubes parallel with each other. Also, the carbon nanotube layer can include multiple stacked carbon nanotube films. The nanotubes in a film can be substantially aligned in the same direction. An angle between the aligned directions of the carbon nanotubes in any two adjacent carbon nanotube layers films is in a range from greater than or equal 0° to less than or equal to 90°.

The carbon nanotube layer can also be comprised of carbon nanotube wires. The carbon nanotube wires arranged in parallel and closely stacked. The carbon nanotube wire is composed of a plurality of successive carbon nanotubes joined end to end by van der Waals attractive force therebetween and are one or more carbon nanotubes in thickness. Also the carbon nanotube wire is composed of a plurality of successive twist carbon nanotubes joined end to end by van der Waals attractive force therebetween. The carbon nanotube wires is parallel to each other and closely located side by side. The length of the carbon nanotube wire can be arbitrarily set as desired. A diameter of each carbon nanotube wire is in an approximate range from 0.5 nanometers to 100 micrometers (μm). Distances which are used as the first grooves 308 or/and the second grooves 328 between adjacent carbon nanotube wires are in an approximate range from 10 nanometers to 1 millimeter. Moreover, the carbon nanotube wires are parallel stacked together to form the carbon nanotube layer. Each carbon nanotube wire includes a plurality of parallel carbon nanotubes, which are attached together by van der Waals attractive force therebetween. The figures represent both embodiments. The carbon nanotube layer that comprises a film is shown wherein the individual carbon nanotubes of the film are shown. In the embodiment comprising of wires, they are shown as well.

The carbon nanotubes in the carbon nanotube films and carbon nanotube wires can be single-walled carbon nanotubes, double-walled carbon nanotubes, or multi-walled carbon nanotubes. Diameters of the single-walled carbon nanotubes are in the approximate range from 0.5 nanometers to 10 nanometers. Diameters of the double-walled carbon nanotubes are in the approximate range from 1 nanometer to 50 nanometers. Diameters of the multi-walled carbon nanotubes are in the approximate range from 1.5 nanometers to 50 nanometers.

In the following description, unless the context indicates otherwise, it will be assumed that each carbon nanotube layer is formed of a single carbon nanotube film.

The second alignment layer 324 can be a conventional alignment layer such as a polyamide layer, or a carbon nanotube layer. In the present embodiment, the second alignment layer 324 is a carbon nanotube layer and a fixing layer. In the present embodiment, the first alignment layer 304 includes a first carbon nanotube layer 304a and a first fixing layer 304b; and the second alignment layer 324 include a second carbon nanotube layer 324a and a second fixing layer 324b. Due to the carbon nanotube layers 304a and 324a having a plurality of parallel and uniform gaps, when the first fixing layer 304b and the second fixing layer 324b are correspondingly formed on the first carbon nanotube layer 304a and the second carbon nanotube layer 324a, the first grooves 308 and the second grooves 328 are accordingly formed on surfaces of the first fixing layer 304 b and the second fixing layer 324b.

The materials of the fixing layers 304b and 324b are selected from the diamond, silicon nitrogen, hydride of random silicon, silicon carbon, silicon dioxide, aluminium oxide, tin oxide, cerium oxide, zinc titanate, and indium titanate. The fixing layers 304b and 324b can be fabricated by an evaporating method, a sputtering method, or by plasma enhanced chemical vapor deposition. Also, the materials of the fixing layers 304b and 324b are selected from polyethylene ethanol, polyamide, polymethyl methacrylate, and polycarbonate. In the present embodiment, the fixing layers 304b and 324b are sprayed on the first carbon nanotube layer 304a and the second carbon nanotube layer 324a. A thickness of the fixing layers is in an approximate range from 20 nanometers to 2 micrometers.

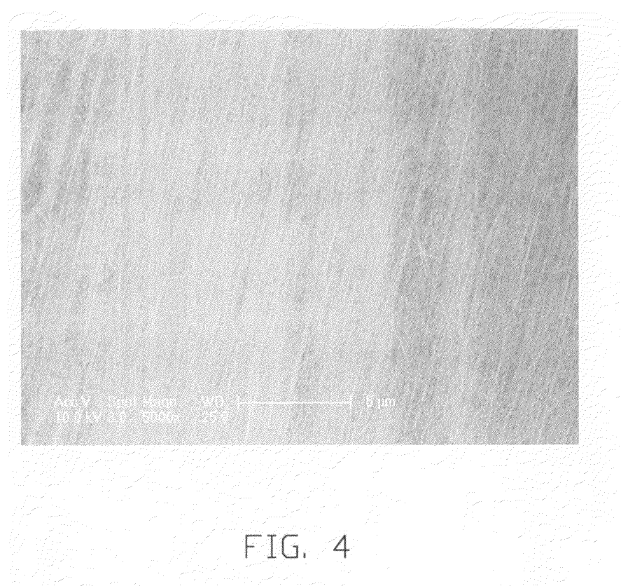

Referring to FIG. 4, SEM image of a carbon nanotube film covered with a fixing layer of the present embodiment, a plurality of grooves forms on the alignment layer, and these grooves are used to align the liquid molecules. The alignment layer includes a carbon nanotube layer and a fixing layer. The carbon nanotube layer includes a plurality of parallel carbon nanotube wires. The fixing layer is silicon dioxide layer, and has a thickness of about 20 nanometers.

In order to keep alignment direction of the first grooves 308 perpendicular to alignment direction of the second grooves 328, the carbon nanotubes arranged direction in the first alignment layer 304 is perpendicular to the carbon nanotubes arranged direction in second alignment layer 324. Specifically, the carbon nanotubes or wires in the first alignment layer 304 each orient parallel to the X-axis, and that of the second alignment layer 324 each orient parallel to the Z-axis. A thickness of the first alignment layer 304 or the second alignment layer 324 are in a range from 20 nanometers to 5 micrometers.

Due to the carbon nanotube layer having good tensile property, when the first substrate 302 and the second substrate 322 are made of flexible materials, the liquid crystal display screen 300 are flexible. Moreover, the carbon nanotube layer has a plurality of carbon nanotubes, thus the carbon nanotube layer has good electrical conductivity. For this, the carbon nanotube layer can be used to conduct electricity, and thereby replace a conventional transparent electrode layer. That is, the carbon nanotube layer can act as both an alignment layer and an electrode layer. This simplifies the structure and reduces the thickness of the liquid crystal display screen 300, and enhances the efficiency of usage of an associated backlight.

Furthermore, by overlapping a fixing layer on the carbon nanotube layer, this makes the carbon nanotube layer of the alignment layer remain in place.

In some embodiments, because the carbon nanotubes or wires in each carbon nanotube layer are arranged in parallel, the carbon nanotube layer has a light polarization characteristic, and thus can be used to replace a conventional polarizer. In other embodiments, at least one polarizer is disposed on a surface of the first substrate 302 that faces away from the liquid crystal layer 338, and/or on a surface of the second substrate 322 that faces away from the liquid crystal layer 338.

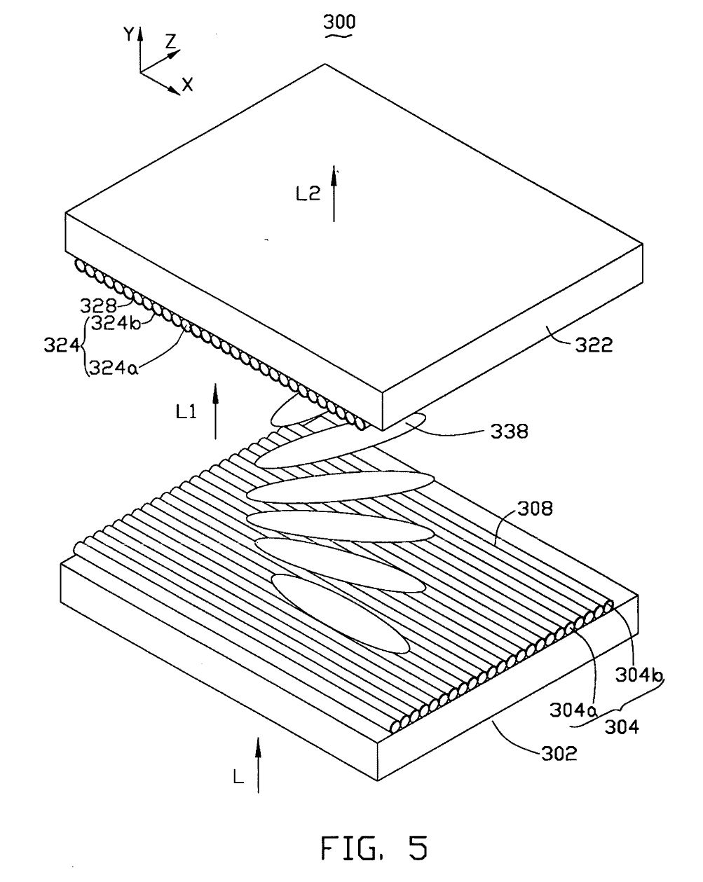

Referring to FIG. 5, when no voltage is applied to the alignment layers 304 and 324, the arrangement of the liquid crystal molecules is in accordance with alignment directions of the alignment layers 304, 324. In this embodiment, the alignment directions of the alignment layer 304s, 324 are at right angles, so the liquid crystal molecules can automatically orient so that they turn a total of 90 degrees from a top of the liquid crystal layer 338 to a bottom of the liquid crystal layer 338. When light L is incident upon the first alignment layer 304, because a transmission axis of the first alignment layer 304 is along the direction of the z-axis, only polarization light L1 with a polarization direction parallel to the transmission/z axis can pass through the first alignment layer 304. When the polarization light L1 passes through the liquid crystal molecules, because the liquid crystal molecules turn 90 degrees from bottom to top, the polarization direction of the polarization light L1 is also turned 90 degrees and becomes parallel to the direction of the x-axis. The polarization light L1 passing through the liquid crystal molecules can pass through the second alignment layer 324 because a transmission axis of the second alignment layer 324 is along the direction of the x-axis. As a result, the liquid crystal display screen 300 transmits light L2.

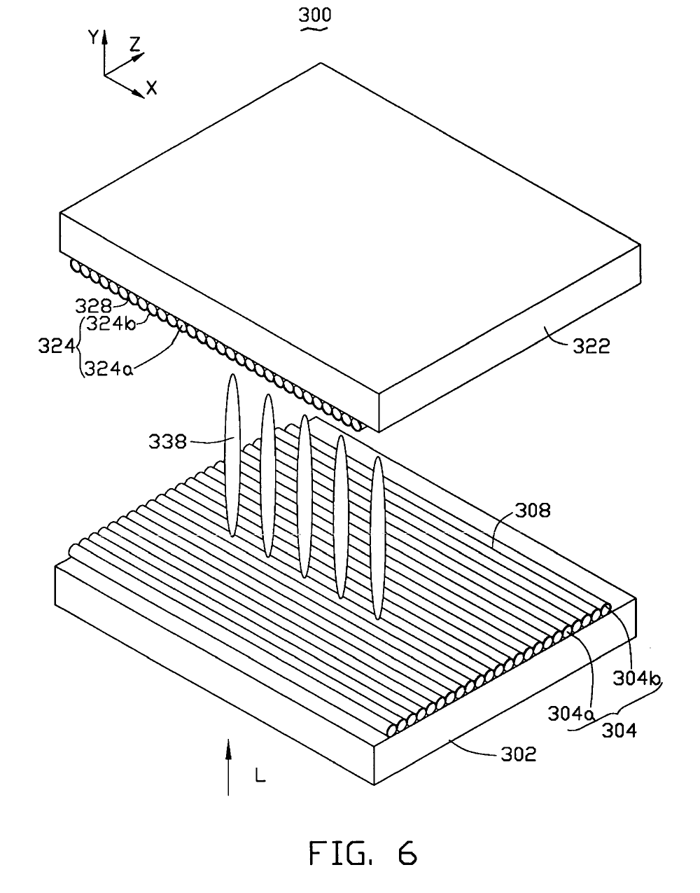

Referring to FIG. 6, when a voltage is applied to the alignment layers 304 and 324, an electrical field with a direction perpendicular to the alignment layers 304 and 324 is formed. Under the influence of the electrical field, the liquid crystal molecules orient to become parallel to the direction of the electrical field. Accordingly, the polarized light L1 passing through the liquid crystal molecules keeps maintains its polarization direction along the z-axis and cannot pass through the second alignment layer 324, whose polarization is along the x-axis. As a result, second alignment layer 324 blocks the light L1.

The present liquid crystal display screen 300 has at least the following advantages. Firstly, each carbon nanotube layer has a plurality of carbon nanotubes, therefore the carbon nanotube layer has excellent electrical conductivity. Thus, the carbon nanotube layer can be used to conduct, and thereby replace a conventional transparent electrode layer. That is, the carbon nanotube layer can act as both an alignment layer and an electrode layer. This simplifies the structure and reduces the thickness of the liquid crystal display screen 300, and enhances the efficiency of usage of an associated backlight. Secondly, the carbon nanotube film is achieved by the pulling out from an array of carbon nanotubes without other mechanical treatment, such as rubbing the carbon nanotube film. Thus, the conventional art problem of electrostatic charge and dust contamination can be avoided, and the corresponding alignment layers 304, 324 have good alignment quality. Thirdly, by overlapping a fixing layer on the carbon nanotube layer, this makes the carbon nanotube layer of the alignment layer not fall off.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A liquid crystal display screen comprising:
a first substrate;
a second substrate opposite to the first substrate;
a liquid crystal layer sandwiched between the first substrate and the second substrate;
a first alignment layer disposed on the first substrate, the first alignment layer comprising a plurality of parallel first grooves;
a second alignment layer disposed on the second substrate, the second alignment layer comprising a plurality of parallel second grooves, an alignment direction of the second grooves being perpendicular to that of the first grooves; and
at least one of the first and second alignment layers comprising a carbon nanotube layer and a fixing layer, the fixing layer being disposed on the carbon nanotube layer, and facing the liquid crystal layer.

2. The liquid crystal display screen of claim 1, wherein materials of the fixing layer are selected from the group consisting diamond, silicon nitrogen, hydride of random silicon, silicon carbon, silicon dioxide, aluminium oxide, tin oxide, cerium oxide, zinc titanate, and indium titanate.

3. The liquid crystal display screen of claim 1, wherein materials of the fixing layer are selected from the group consisting polyethylene ethanol, polyamide, polymethyl methacrylate, and polycarbonate.

4. The liquid crystal display screen of claim 1, wherein a thickness of the fixing layer is in an approximate range from 20 nanometers to 2 micrometers.

5. The liquid crystal display screen of claim 1, wherein the carbon nanotube layer comprises at least one carbon nanotube film.

6. The liquid crystal display screen of claim 5, wherein each carbon nanotube film comprises a plurality of carbon nanotube segments joined end by end by Waals attractive force therebetween.

7. The liquid crystal display screen of claim 6, wherein each carbon nanotube segment comprises a plurality of carbon nanotubes parallel with other.

8. The liquid crystal display screen of claim 7, wherein the carbon nanotube layer comprises multiple stacked carbon nanotube films, an angle between the aligned directions of the carbon nanotubes in any two adjacent carbon nanotube films is in a range from 0° to 90°.

9. The liquid crystal display screen of claim 1, wherein the carbon nanotube layer comprises a plurality of parallel carbon nanotube wires.

10. The liquid crystal display screen of claim 9, wherein each carbon nanotube wire comprises a plurality of carbon nanotubes joined end to end.

11. The liquid crystal display screen of claim 10, wherein the carbon nanotube wires form a plurality of uniform distributed and parallel gaps.

12. The liquid crystal display screen of claim 11, wherein a surface of the fixing layer has a plurality of uniform distributed and parallel gaps formed thereon and according to the gaps of the carbon nanotube layer, and the gaps of the fixing layer form grooves.

13. The liquid crystal display screen of claim 10, wherein the carbon nanotubes in the carbon nanotube layer are selected from a group consisting of single-walled carbon nanotubes, double-walled carbon nanotubes, and multi-walled carbon nanotubes; and a diameter of the single-walled carbon nanotubes is in a range from 0.5 nanometers to 50 nanometers, a diameter of the double-walled carbon nanotubes is in a range from 1 nanometer to 50 nanometers, and a diameter of the multi-walled carbon nanotube is in a range from 1.5 nanometers to 50 nanometers.

14. The liquid crystal display screen of claim 9, wherein the first alignment layer and the second alignment layer respectively comprise a carbon nanotube layer and a fixing layer, and an aligned direction of the carbon nanotube wires in the first alignment layer being perpendicular to that of the carbon nanotube wires in the second alignment layer.

15. The liquid crystal display screen of claim 1, wherein a thickness of the first/second alignment layer is in an approximate range from 20 nanometers to 5 micrometers.

16. The liquid crystal display screen of claim 1, wherein the first substrate and the second substrate are made of flexible and transparent materials.

17. The liquid crystal display screen of claim 16, wherein the flexible and transparent materials comprise of cellulose triacetate.

18. The liquid crystal display screen of claim 1, further comprising at least one polarizer, the at least one polarizer is located on the first substrate, the second substrate, or the first and second substrate.
